(19) United States
(12) Patent Application Publication
(10) Pub. No.: US 2005/0262331 A1
(43) Pub. Date: Nov. 24, 2005

(54) Controller and method for processing instructions

(75) Inventors: Franz Klug, Munich (DE); Oliver Kniffler, Munich (DE); Steffen Marc Sonnekalb, Taufkirchen (DE); Andreas Wenzel, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/134,612

(22) Filed: May 20, 2005

(30) Foreign Application Priority Data
May 24, 2004 (DE) 10 2004 025 419.2

(51) Int. Cl. G06F 9/30

(52) U.S. Cl. 712/226

(57) ABSTRACT

A controller having a receiver for receiving an instruction, a comparator for comparing the received instruction to a predetermined wildcard instruction, the comparator providing a switch signal to a provider for providing a predetermined substitution instruction responsive to the predetermined wildcard instruction. Depending on the switch signal, the provider outputs the received instruction or the other instruction.

### CROSS-REFERENCE TO RELATED APPLICATION

This application claims priority from German Patent Application No. 10 2004 025 419.2, which was filed on May 24, 2004, and is incorporated herein by reference in its entirety.

### BACKGROUND OF THE INVENTION

1. Field of the Invention

The present invention relates to a controller and, in particular, to the processing of instructions by the controller.

2. Description of Related Art

A microprocessor or, in general, a controller comprises a defined set of instructions. This instruction set is used to write a computer program which will be executed by the microprocessor. For this, the microprocessor comprises a decoding unit converting the program instructions to control signals. The control signals are processed by a calculating unit of the microprocessor. Modern microprocessors are typically based on a 32-bit architecture. This means that they are able to process 32-bit instructions. Apart from 32-bit instructions, a 32-bit microprocessor can usually also process 16-bit instructions. 32-bit instructions allow executing complex functions. Compared to 16-bit instructions, they require a larger amount of memory space. When a certain algorithm is implemented by a programmer, the situation may arise that certain instructions occur very frequently. If these frequently used instructions are 32-bit instructions, they will require a large amount of program memory.

In particular in micro-controllers employed in the area of chip cards, the memory space available for a program is limited. Frequently used 32-bit instructions having a large memory space demand may cause memory space problems. Another disadvantage of the 32-bit instructions is a decrease in the code size-performance ratio of a micro-controller system due to poorer cache utilization since, compared to 16-bit instructions, only half as many 32-bit instructions can be stored in a cache having a predetermined cache size.

For FPGA solutions, there are solutions as to how reconfigurable CPUs may appear. Furthermore, there is a way of granting a programmer more freedom by means of a micro-code and of generating a programmable code in this way. These possibilities, however, are of disadvantage since they can either not be employed for systems fixedly cast in hardware or comprise small flexibility.

### SUMMARY OF THE INVENTION

It is an object of the present invention to provide a controller and a method for processing instructions and a computer program for executing the method, allowing great flexibility at moderate additional expenditure.

In accordance with a first aspect, the present invention provides a controller having: a receiver for receiving an instruction; a comparator formed to provide a switch signal responsive to the received instruction corresponding to a predetermined wildcard instruction; and a provider formed to output the received instruction or a predetermined substitute instruction depending on the switch signal.

In accordance with a second aspect, the present invention provides a method for receiving instructions, having the steps of: (a) receiving an instruction; (b) providing a switch signal responsive to the received instruction corresponding to a predetermined wildcard instruction; and (c) outputting the received instruction or a predetermined substitute instruction depending on the switch signal.

In accordance with a third aspect, the present invention provides a computer program having a program code for performing the above mentioned method when the computer program runs on a computer.

### BRIEF DESCRIPTION OF THE DRAWINGS

Preferred embodiments of the present invention will be detailed subsequently referring to the appended drawings, in which:

FIG. 1 shows a schematic illustration of a controller according to the present invention;

FIG. 2 shows a detailed schematic illustration of a controller according to the present invention; and

FIG. 3 shows another embodiment of a controller according to the present invention.

### DESCRIPTION OF THE PREFERRED EMBODIMENTS

Same or similar reference numerals will be used in the subsequent description of the preferred embodiments of the present invention for elements illustrated in the different drawings and having similar effects, a repeated description of these elements being omitted.

The present invention is based on the finding that an additional resource built into a controller allows an improved code size-performance ratio of a controller system.

The present invention allows mapping instructions or instruction op-codes already present to shorter op-codes on a controller or microprocessor. This is of particular value for programmers frequently requiring special instructions having long op-codes. Instructions of this kind may, according to the present invention, be executed in a long form, such as, for example, a 32-bit implementation, or bypassed in combination with a smaller, for example 16-bit wildcard instruction and thus implemented in a code-saving way.

An advantage of the present invention is an improved code size-performance ratio of the micro-controller. Additionally, the performance is increased by improved cache utilization. Another essential advantage in this context is the possibility of substituting erroneous instructions and thus obtaining a higher design security.

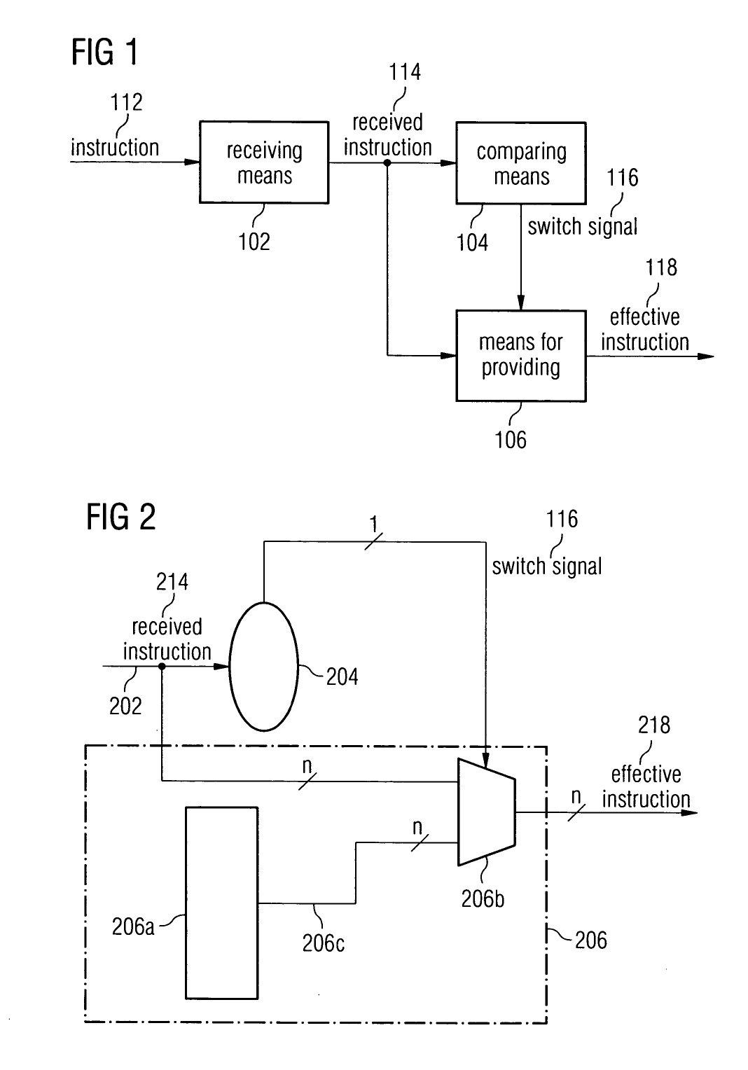

FIG. 1 shows a schematic illustration of a controller according to the present invention. The controller comprises receiving means 102, comparing means 104 and means 106 for providing. The receiving means 102 is formed to receive an instruction 112 and to provide the received instruction 114 to the comparing means 104 and the means 106 for providing. The comparing means 104 is formed to compare the received instruction 114 to a predetermined wildcard instruction. Depending on a comparison result, the comparing means 104 provides a switch signal 116 to the means 106 for providing. Depending on the switch signal 116, the means 106 for providing will output the received instruction 114 or a predetermined substitute instruction as an effective instruction 118. The effective instruction is typically received and decoded by decoding means (not shown in FIG. 1).

An instruction is typically a machine-readable instruction comprising an op-code and an operand. The op-code defines an operation to be executed by the instruction. Op-codes are usually short and limited by the instruction set. An operand defines values to be processed by the op-code, which are transferred directly or are present in registers or memories. Operands are only limited by a system's architecture.

The instruction 112 is an instruction from an instruction set defined for the controller. The instruction set comprises at least one predetermined wildcard instruction. The predetermined wildcard instruction will, in contrast to other instructions of the instruction set, subsequently be referred to as a normal instruction, not decoded by the controller and thus does not invoke an operation in a calculating unit (not shown in FIG. 1) of the controller. The predetermined wildcard instruction is characterized by the smallest possible bit width.

The receiving means 102 for receiving the instruction 112 typically is an input buffer of the controller. Alternatively, the receiving means 102 may be a transit line. Corresponding to its design, the receiving means 102 will output the instruction 112 directly or, for example, in a clocked form as the received instruction 114. The comparing means 104 checks whether the received instruction 114 is the predetermined wildcard instruction or a normal instruction. The switch signal provided by the comparing means 104 indicates whether the received instruction 114 is the predetermined wildcard instruction or a normal instruction. If the received instruction 114 is a normal instruction, the controller will be output by the means 106 for providing as an effective instruction 118. If, however, the received instruction 114 is the predetermined wildcard instruction, the means 106 for providing will not output the predetermined wildcard instruction as an effective instruction 118 but a predetermined substitute instruction in a way controlled by the switch signal 116. The predetermined substitute instruction is stored in the means 106 for providing a predetermined substitute instruction.

Alternatively, the wildcard instruction may also be an executable or normal instruction.

FIG. 2 shows a detailed schematic illustration of an embodiment of the controller shown in FIG. 1. In this embodiment, receiving means 202 is realized as a line which, for example, emanates from a program memory (not shown in FIG. 2), such as, for example, a cache architecture, and provides a received instruction 214 to comparing means 204. According to this embodiment, means 206 for providing comprises memory means 206a, switching means 206b and a substitute instruction line 206c. The comparing means 204 is connected to the switching means 206b via a switch signal 216. The switching means 206b outputs an effective instruction 218.

In this embodiment, the received instruction 214 is an n-bit instruction. The memory means 206a is formed to store a predetermined n-bit substitute instruction and the substitute instruction line 206c also comprises a width of n bits. The switching means 206b is connected to both the receiving means 202 for receiving the received instruction 214 and to the substitute instruction line 206c for receiving the predetermined substitute instruction. Controlled by the switch signal 216, the switching means 206b will output either the received instruction 214 or the predetermined substitute instruction. The switch signal 216 in this embodiment is formed as a 1-bit signal. This is sufficient since the switch signal 216 only indicates whether the comparing means 204 has recognized a normal instruction or a predetermined wildcard instruction as the received instruction 214.

According to a special embodiment, the comparing means 204 is a decoder, the memory means 206a is a CSFR register which can be loaded by means of an MTCR operation, and the switching means 206b is a multiplexer. The controller is an 88 controller and the received instructions 214 correspond to a 32-bit op-code or to a 16-bit op-code. The predetermined wildcard instruction is a 16-bit op-code. The MTCR operation is triggered by a write instruction writing the predetermined substitute instruction to the CSFR register. The CSFR register is a holding register storing the predetermined substitute instruction. A new substitute instruction may be defined as a CSFR entry by writing to the additional CSFR by means of the MTCR operation, even during a program run. An additional 16-bit op-code in the form of the predetermined wildcard instruction is interpreted by the decoder 204 such that an alternative to the defined instruction will be executed instead of a decoded instruction.

The architecture described referring to FIG. 2 uses an additional built-in resource in the form of the CSFR and thus allows an improved code size-performance ratio of the controller adding a relatively small additional area, for example by defining one or several CSFRs and a reserved 16-bit op-code as a wildcard instruction.

Put differently, FIG. 2 shows a schematic overview of a system in which a substitute instruction or effective instruction 211 can be transferred to a CPU (not shown in FIG. 2) according to the present invention by programming a CSFR and by using an additional op-code in the form of a predetermined wildcard instruction.

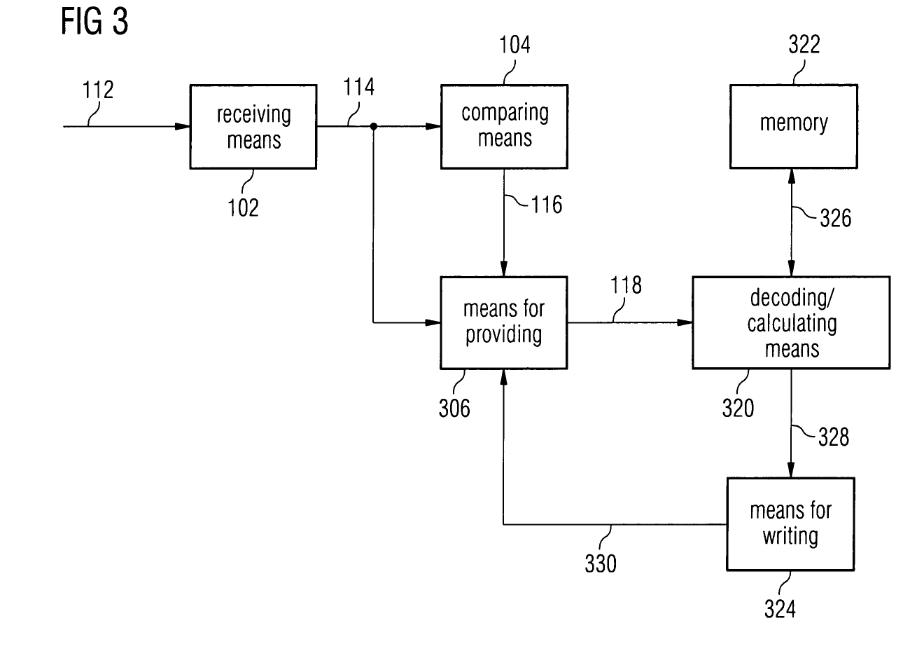

FIG. 3 shows a schematic illustration of another embodiment of the present invention. According to the description of FIG. 1, the controller shown in FIG. 3 comprises receiving means 102 and comparing means 104. Means 306 for providing in this embodiment comprises an additional input. The means 306 for providing provides the effective instruction 118 to decoding/calculating unit 320 of the controller. The decoding/calculating unit 320 is connected to memory means 322 and to means 324 for writing. The decoding/calculating means 320 is connected to the memory means 322 via a memory signal 326 and connected to the means 324 for writing via a write control signal 328. The means 324 for writing is connected to the means 306 for providing via a write signal 330. A predetermined substitute instruction is written to the means 306 for providing a predetermined substitute instruction via the write signal 330. The predetermined substitute instruction is stored in the means 306 for providing and output as an effective instruction 118 in a way controlled by the switch signal 116 until a new predetermined substitute instruction is written to the means 306 for providing by the write signal 316. The decoding/calculating means 320 is formed to decode the received instruction or the predetermined substitute instruction to a control signal. The control signal causes calculating means, which in this embodiment is integrated in the decoding/calculating means 320 or realized additionally as means 324 for writing, to execute an operation defined by the received instruction or the predetermined substitute instruction.

The predetermined substitute instruction is preferably defined by a program executed by the controller. When a program portion comprises a frequently recurring instruction requiring more memory space than the predetermined wildcard instruction, it is of advantage to substitute the frequently recurring instruction in this program portion by the predetermined wildcard instruction. Before the predetermined wildcard instruction 102 is received for the first time by the receiving means 102, the substituted instruction in the form of the predetermined substitute instruction is written to the means for providing 306. Typically, this takes place via a special write instruction. A substitution of frequently recurring instructions by a predetermined wildcard instruction can be performed directly by a programmer or by a correspondingly designed compiler converting a program to a machine-readable sequence of instructions, the instructions of the sequence of instruction originating from the instruction set of the controller.

According to an embodiment, an instruction for writing a predetermined substitute instruction to the means 306 for providing causes the decoding/calculating means 320 to write the predetermined substitute instruction to the means 306 for providing via the means 324 for writing. Here, the predetermined substitute instruction is defined by the instruction for writing. Alternatively, the predetermined substitute instruction is stored in the memory 322. Several predetermined substitute instructions may be stored fixedly in the memory cells of the memory 322 or as a result of an initializing routine or due to a program run. In this case, the instruction for writing causes the decoding/calculating means 320 to read out a predetermined substitute instruction from a memory cell and to write it to the means 306 for providing via the means 324 for writing.

According to another embodiment, means for providing comprises several substitution instructions or several means for providing are implemented in a controller. This allows using an instruction sequence including several instructions by a single predetermined wildcard instruction. When the controller additionally comprises a plurality of comparing means or when comparing means can differentiate between several predetermined wildcard instructions and can indicate this via an extended change-over signal, different predetermined wildcard instructions corresponding to different normal instructions can be employed in a program.

The fact that a decoder according to the inventive approach is enabled to change instructions by multiplexing the op-code stream and the content of the CSFR allows programming a reconfigurable instruction. This allows an alternative op-code to each instruction of the core. Thus, the possibility arises to represent 32-bit instructions by 16-bit instructions. In the same way, it is also possible to substitute a 16-bit instruction by another 16-bit instruction. Thus, a 32-bit architecture is only chosen as an example. The inventive approach may be employed of advantage in any other architecture, in particular also in a 64-bit architecture.

An essential aspect in this context is the possibility of substituting erroneous instructions and thus obtaining a higher design security. It is possible to file instructions in a memory, such as, for example, an NVM, to load them to a register file and write them to the CSFR by means of an MTCR operation and then execute them by a short op-code.

Instead of the predetermined wildcard instruction which is a defined instruction of the controller instruction set, a non-defined instruction may also be used when the comparing means is formed to provide the change-over signal responsive to recognizing a non-defined instruction.

According to another embodiment, the comparing means is programmable and any instruction may be programmed into the comparing means as the predetermined wildcard instruction.

As an alternative to the described write process of a predetermined substitute instruction to the means for providing, any other way may be employed to define a predetermined substitute instruction in the means for providing. The substitute instruction, for example, can also be programmed fixedly or be programmed via additional control means, for example by control lines lead out from the controller. The controller may be a circuit for processing instructions according to the inventive approach, a micro-controller or microprocessor having a simple architecture or a sophisticated processor. The decoding/calculating means shown in FIG. 3 represents any calculating unit and, in particular, a plurality of calculating units, such as, for example, a CPU or ALU of a microprocessor.

Depending on the circumstances, the inventive method may be implemented in either hardware or software. The implementation may be on a digital storage medium, in particular on a disc or a CD having control signals which can be read out electronically, which can cooperate with a programmable computer system such that the corresponding method will be executed. In general, the invention also includes a computer program product having a program code stored on a machine-readable carrier for performing the inventive method when the computer program product runs on a computer. Put differently, the invention may also be realized as a computer program having a program code for performing the method when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A controller comprising:
a receiver for receiving an instruction;
a comparator formed to provide a switch signal responsive to the received instruction corresponding to a predetermined wildcard instruction; and
a provider formed to output the received instruction or a predetermined substitute instruction depending on the switch signal.

2. The controller according to claim 1, wherein the provider is formed to receive and store the predetermined substitute instruction.

3. The controller according to claim 2, further comprising a writer formed to write the predetermined substitute instruction to the provider responsive to a write instruction.

4. The controller according to claim 3, further comprising a memory for storing the predetermined substitute instruction, the writer being formed to write the predetermined substitute instruction from the memory to the provider responsive to the write instruction.

5. The controller according to claim 1, further comprising a decoder formed to decode the received instruction or the predetermined substitute instruction to a control signal for controlling a calculator.

6. The controller according to claim 1, wherein the predetermined substitute instruction is part of an instruction set of the controller.

7. The controller according to claim 6, wherein the wildcard instruction is part of the instruction set of the controller.

8. The controller according to claim 1, wherein the predetermined substitute instruction comprises a greater bit width than the predetermined wildcard instruction.

9. The controller according to claim 1, wherein the provider comprises a register for holding the predetermined substitute instruction.

10. The controller according to claim 1, wherein the provider comprises a multiplexer formed to output the received instruction or the predetermined substitute instruction depending on the switch signal.

11. The controller according to claim 1, further comprising a plurality of providers formed to output the received instruction or a plurality of predetermined substitute instructions depending on the switch signal.

12. A method for receiving instructions, comprising the steps of:
(a) receiving an instruction;
(b) providing a switch signal responsive to the received instruction corresponding to a predetermined wildcard instruction; and
(c) outputting the received instruction or a predetermined substitute instruction depending on the switch signal.

13. A computer program having a program code for performing a method for receiving instructions, comprising the steps of: (a) receiving an instruction; (b) providing a switch signal responsive to the received instruction corresponding to a predetermined wildcard instruction; and (c) outputting the received instruction or a predetermined substitute instruction depending on the switch signal, when the computer program runs on a computer.

14. A controller for receiving instructions, comprising:
(a) means for receiving an instruction;
(b) means for providing a switch signal responsive to the received instruction corresponding to a predetermined wildcard instruction; and
(c) means for outputting the received instruction or a predetermined substitute instruction depending on the switch signal.

15. The controller according to claim 14, wherein the means for providing comprises means for receiving and storing the predetermined substitute instruction.

16. The controller according to claim 15, further comprising a means for writing the predetermined substitute instruction to the provider responsive to a write instruction.

17. The controller according to claim 16, further comprising a memory means for storing the predetermined substitute instruction, the means for writing being formed to write the predetermined substitute instruction from the memory means to the means for providing responsive to the write instruction.

18. The controller according to claim 14, further comprising a means for decoding the received instruction or the predetermined substitute instruction to a control signal for controlling a calculator.

19. The controller according to claim 14, wherein the means for providing comprises a register means for holding the predetermined substitute instruction.

20. The controller according to claim 14, wherein the means for providing comprises a multiplexer means for outputting the received instruction or the predetermined substitute instruction depending on the switch signal.

21. The controller according to claim 14, further comprising a plurality of means for providing each formed to output the received instruction or a plurality of predetermined substitute instructions depending on the switch signal.
